(19) United States
(12) Patent Application Publication
(10) Pub. No.: US 2016/0357319 A1
(43) Pub. Date: Dec. 8, 2016

(54) ELECTRONIC DEVICE AND METHOD FOR CONTROLLING THE ELECTRONIC DEVICE

(71) Applicant: Samsung Electronics Co., Ltd., Suwon-si (KR)

(72) Inventors: Hyun-woo KIM, Suwon-si (KR); Min-su CHO, Suwon-si (KR); Joong-hee MOON, Seongnam-si (KR); Kun-woo BAEK, Suwon-si (KR); Tahk-guhn LEE, Suwon-si (KR)

(21) Appl. No.: 15/165,538

(22) Filed: May 26, 2016

Related U.S. Application Data
(60) Provisional application No. 62/169,862, filed on Jun. 2, 2015.

(30) Foreign Application Priority Data
Jul. 10, 2015 (KR) 10-2015-0098177

(51) Int. Cl. G06F 3/041; G06F 3/0488

(52) U.S. Cl. CPC G06F 3/0416; G06F 3/0412; G06F 3/04883; G06F 2203/04104

(57) ABSTRACT

An electronic device and a method for controlling the same are provided. The method includes obtaining a depth image using a depth camera, extracting a hand area including a hand of a user from the obtained depth image, modeling fingers and a palm of the user included in the hand area into a plurality of points, and sensing a touch input based on depth information of one or more of the plurality of modeled points.

### CROSS-REFERENCE TO RELATED APPLICATION(S)

This application claims the benefit under 35 U.S.C. §119(e) of a U.S. Provisional application filed on Jun. 2, 2015 in the U.S. Patent and Trademark Office and assigned Ser. No. 62/169,862, and under 35 U.S.C. §119(a) of a Korean patent application filed on Jul. 10, 2015 in the Korean Intellectual Property Office and assigned Serial number 10-2015-0098177, the entire disclosure of each of which is hereby incorporated by reference.

### TECHNICAL FIELD

The present disclosure relates to an electronic device and a method for controlling the electronic device. More particularly, the present disclosure relates to an electronic device for sensing a user's touch input using depth information of the user's hand obtained by a depth camera, and a method for controlling the electronic device.

### BACKGROUND

Various research is being conducted to develop a large size interactive touch screen that includes a beam projector. Of these, efforts are being made to develop a method for sensing a user's touch using a depth camera adopted into the beam projector. More specifically, a beam projector senses a user's touch input based on a difference between a depth image obtained by the depth camera and a plane depth image.

In such a case, when the user places his/her palm on a plane, a touch will occur due to the palm, and thus in order to input a touch, the user would have to keep his/her palm in the air, which is inconvenient. Not only that, when a noise occurs due to an environmental element such as light entering from the surrounding environment, since it is difficult to differentiate between the noise and a touch of the hand, a noise touch may occur, which is also a problem.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device that is configured to model a hand of a user obtained by a depth camera into a plurality of points, and to sense a touch input of the user based on depth information on the plurality of points that have been modeled, and a method for controlling the electronic device.

In accordance with an aspect of the present disclosure, a method for controlling an electronic device is provided. The method includes obtaining a depth image using a depth camera, extracting a hand area including a hand of a user from the obtained depth image, modeling fingers and a palm of the user included in the hand area into a plurality of points, and sensing a touch input based on depth information of one or more of the plurality of modeled points.

The modeling may involve modeling each of an index finger, middle finger, and ring finger of the fingers of the user into a plurality of points, modeling each of a thumb and little finger of the fingers of the user into one point, and modeling the palm of the user into one point.

The sensing may involve, in response to sensing that only an end point of at least one finger from among the plurality of points of the index finger and middle finger has been touched, sensing a touch input at the touched point, and in response to sensing that a plurality of points of at least one finger from among the plurality of points of the index finger and middle finger have been touched, not sensing the touch input.

The sensing may involve, in response to sensing that only end points of two fingers from among the plurality of points of the thumb and index finger have been touched, sensing a multi touch input at the touched point, and in response to sensing that the plurality of points of the index finger and the one point of the thumb have all been touched, not sensing the touch input.

The sensing may involve, in response to sensing that only end points of two fingers from among the plurality of points of the index fingers of both hands of the user have been touched, sensing a multi touch input at the touched point.

Furthermore, the method may involve, in response to sensing that only end points of all fingers from among the plurality of points of all fingers of both hands of the user have been touched, sensing a multi touch input.

The method may include analyzing a movement direction and speed of the hand included in the hand area, wherein the extracting involves extracting the hand of the user based on a movement direction and speed of the hand analyzed in a previous frame.

The method may include determining whether an object within the obtained depth image is a hand or thing by analyzing the obtained depth image, and in response to determining that the object within the depth image is a thing, determining a type of the thing.

The method may include performing functions of the electronic device based on the determined type of the thing and touch position of the thing.

In accordance with an aspect another aspect of the present disclosure, an electronic device is provided. The electronic device includes a depth camera configured to obtain a depth image, and a controller configured to extract a hand area including a hand of a user from the obtained depth image, to model the fingers and palm of the user included in the hand area into a plurality of points, and to sense a touch input based on depth information of one or more of the plurality of modeled points.

The controller may model each of an index finger, middle finger, and ring finger from among the fingers of the user into a plurality of points, model each of a thumb and little finger of the fingers of the user into one point, and model the palm of the user into one point

The controller may, in response to sensing that only an end point of at least one finger from among the plurality of points of the index finger and middle finger have been touched, sense a touch input at the touched point, and in response to sensing that a plurality of points of at least one finger from among the plurality of points of the index finger and middle finger have been touched, may not sense the touch input.

The controller may, in response to sensing that only end points of two fingers from among the plurality of points of the thumb and index finger have been touched, sense a multi touch input at the touched point, and in response to sensing that the plurality of points of the index finger and one point of the thumb have all been touched, may not sense the touch input.

The controller may, in response to sensing that only end points of two fingers from among the plurality of points of the index fingers of both hands of the user have been touched, sense a multi touch input at the touched point.

The electronic device may, in response to sensing that only end points of all fingers from among the plurality of points of all fingers of both hands of the user have been touched, sense a multi touch input.

The controller may analyze a movement direction and speed of the hand included in the hand area, and may extract the hand of the user based on a movement direction and speed of the hand analyzed in a previous frame.

The controller may determine whether an object within the obtained depth image is the hand of the user or a thing by analyzing the obtained depth image, and in response to determining that the object within the depth image is a thing, determine a type of the thing.

The controller may perform functions of the electronic device based on the determined type of the thing and touch position of the thing.

The electronic device may further include an image projector configured to project an image onto a touch area.

According to the various aforementioned embodiments of the present disclosure, user convenience of a touch input using a depth camera may be improved. Furthermore, the electronic device may provide various user inputs using the depth camera.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWING

The above and other aspects, features, and advantages of certain embodiments of the present disclosure will be more apparent from the following description taken in conjunction with the accompanying drawings, in which:

FIG. 1 is a block diagram schematically illustrating a configuration of an electronic device according to an embodiment of the present disclosure;

FIG. 2 is a block diagram illustrating in detail a configuration of an electronic device according to an embodiment of the present disclosure;

FIGS. 3A, 3B, 3C, and 4 are views for explaining extracting a hand area from a depth image obtained from a depth camera, and modeling a finger and palm of the extracted hand area into a plurality of points according to an embodiment of the present disclosure;

FIGS. 5A, 5B, 5C, 5D, 6A, 6B, 6C, 6D, 7A, 7B, 8A, and 8B are views for explaining determining a touch input based on depth information on a plurality of points according to various embodiments of the present disclosure;

FIG. 9 is a view illustrating a touch area according to an embodiment of the present disclosure;

FIGS. 10A, 10B, 11A, 11B, and 11C are views for explaining controlling an electronic device using a thing according to an embodiment of the present disclosure;

FIGS. 12 and 13 are flowcharts for explaining a method for controlling an electronic device according to an embodiment of the present disclosure;

FIG. 14 is a view for explaining controlling an electronic device through an external user terminal according to an embodiment of the present disclosure; and

FIGS. 15A and 15B are views illustrating a stand type electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the various embodiments of the present disclosure, terms including ordinal numbers such as ‘a first’, ‘a second’ and the like may be used to explain various components, but the components are not limited by those terms. The terms are used to differentiate one component from other components. For example, a first component may be named a second component without escaping from the scope of the claims, and in the same manner, a second component may be named a first component. The term ‘and/or’ includes a combination of a plurality of objects or any one of the plurality of objects.

Furthermore, in the various embodiments of the present disclosure, terms such as ‘include’ or ‘have/has’ should be understood as designating the existence of a feature, number, operation, component, part, or a combination thereof disclosed in the specification, and not as excluding the existence of a feature, number, operation, component, part, or a combination thereof or possibility of addition thereof.

Furthermore, in the various embodiments of the present disclosure, a ‘module’ or ‘unit’ may be realized as hardware, software or a combination of hardware and software that performs at least one function or operation. Furthermore, a plurality of ‘modules’ or a plurality of ‘units’ may be integrated into at least one module and be realized as at least one processor except for ‘modules’ or ‘units’ that need to be realized as a particular hardware.

Furthermore, in the various embodiments of the present disclosure, when one part is ‘connected’ to another part, it may be ‘directly connected’ or ‘electrically connected’ with another element therebetween.

Furthermore, in the various embodiments of the present disclosure, a ‘touch input’ may include a touch gesture that a user performs on a display and cover in order to control the electronic device. Furthermore, the ‘touch input’ may include a touch (for example, floating or hovering) that is not touching the display but is spaced by a certain distance.

Furthermore, in the various embodiments of the present disclosure, an ‘application’ is a set of series of computer programs devised to perform a certain task. In the various embodiments of the present disclosure, there may be various kinds of applications, for example a game application, video replay application, map application, memo application, calendar application, phone book application, broadcast application, exercise supporting application, payment settlement application, and photo folder application, but without limitation.

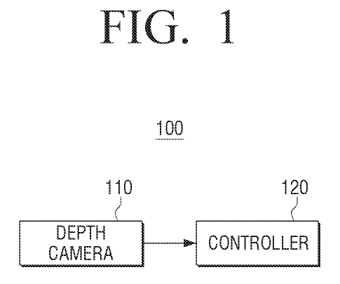

Hereinafter, the present disclosure will be explained in further detail with reference to the drawings attached. First of all, FIG. 1 is a block diagram schematically illustrating a configuration of an electronic device 100.

Referring to FIG. 1, the electronic device 100 includes a depth camera 110 and controller 120.

The depth camera 110 obtains a depth image of a certain area. More specifically, the depth camera 110 may photograph a depth image of a touch area where an image is projected.

The controller 120 controls overall operations of the electronic device 100. Especially, the controller 120 may extract a hand area which includes the user's hand from a depth image obtained through the depth camera 110, model fingers and a palm of the user included in the hand area into a plurality of points, and sense a touch input based on depth information on the plurality of modeled points.

More specifically, the controller 120 may analyze the depth image obtained through the depth camera 110 and determine whether or not an object in the depth image is the user's hand or a thing. More specifically, the controller 120 may measure a difference between a plane depth image of a display area where there was no object and a photographed depth image, so as to determine a shape of the object in the depth image.

In addition, in response to determining that there is a shape of the user's hand in the depth image, the controller 120 may detect a hand area in the depth image. Herein, the controller 120 may remove a noise from the depth image, and detect the hand area where the user's hand is included.

Furthermore, the controller 120 may model the user's palm and fingers included in the extracted hand area into a plurality of points. More specifically, the controller 120 may model an index finger, middle finger, and ring finger from among the fingers of the user into a plurality of points, model a thumb and little finger into one point, and model a palm into one point.

In addition, the controller 120 may sense a user's touch input based on depth information on the plurality of modeled points. More specifically, in response to sensing that only an end point of one finger from among the plurality of points of the index finger and middle finger has been touched, the controller 120 may sense a touch input in a touched point, and in response to sensing that a plurality of points of at least one finger from among the plurality of points of the index finger and middle finger have been touched, the controller 120 may not sense a touch input.

Furthermore, in response to sensing that only end points of two fingers from among the plurality of points of the thumb and index finger have been touched, the controller 120 may sense a multi touch input using the thumb and index finger, and in response to sensing that all the plurality of points of the index finger and one point of the thumb have been touched, the controller 120 may not sense a touch input using the thumb and index finger.

Furthermore, in response to sensing that only end points of two fingers from among the plurality of points of the index fingers of both hands of the user have been touched, the controller 120 may sense a multi touch input using the index fingers of both hands, and in response to sensing that only end points of all fingers of both hands of the user have been touched, the controller 120 may sense a multi touch input using both hands.

Furthermore, the controller 120 may analyze a movement direction and speed of the hand included in the hand area in order to determine a user's touch action more quickly, and may extract the user's hand area based on the movement direction and speed analyzed in a previous frame.

However, in response to determining that an object in a depth area is a thing, the controller 120 may determine the type of the thing extracted. That is, the controller 120 may compare the shape of a pre-registered thing with the thing placed on the touch area, so as to determine the type of the thing placed on the touch area. Furthermore, the controller 120 may perform functions of the electronic device 100 based on at least one of the determined type of the thing and a touch position of the thing.

By using the aforementioned electronic device 100, it is possible for the user to perform a touch input using the depth camera more efficiently.

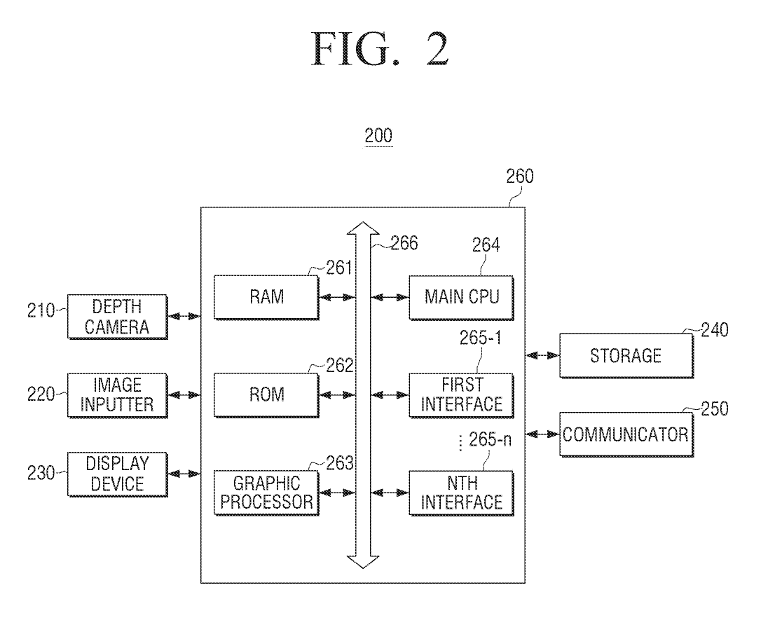

Hereinafter, the present disclosure will be explained in more detail with reference to FIGS. 2, 3A, 3B, 3C, 4, 5A, 5B, 5C, 5D, 6A, 6B, 6C, 6D, 7A, 7B, 8A, 8B, 9, 10A, 10B, 11A, 11B, and 11C.

First of all, FIG. 2 is a block diagram illustrating in detail a configuration of an electronic device 200 according to an embodiment of the present disclosure.

Referring to FIG. 2, the electronic device 200 includes a depth camera 210, image inputter 220, display device 230, storage 240, communicator 250 and controller 260.

Meanwhile, FIG. 2 is a comprehensive illustration of various components based on an example that the electronic device 200 is a device that has various functions such as a function of providing contents, display function and the like. Therefore, in an embodiment, some of the components illustrated in FIG. 2 may be omitted or changed, or more components may be added.

The depth camera 210 obtains a depth image of a certain area. Especially, in a case of the electronic device 200 displaying an image using a beam projector, the depth camera 210 may obtain a depth image of a display area where an image is being displayed by light projected by the beam projector.

The image inputter 220 receives input of image data through various sources. For example, the image inputter 220 may receive broadcast data from an external broadcasting station, receive input of video on demand (VOD) data in real time from an external server, or receive input of image data from an external device.

The display device 230 may display image data input through the image inputter 220. Herein, the display device 230 may output image data in a beam projector method. Especially, the display device 230 may project light using a digital light processing (DLP) method, but without limitation, and thus the display device 230 may project light in other methods.

Furthermore, the display device 230 may be realized as a general display device and not in the beam projector method. For example, the display device 230 may be realized in various formats such as a liquid crystal display (LCD), organic light emitting diodes (OLED) display, active-matrix organic light-emitting diode (AM-OLED), and plasma display panel (PDP). The display device 230 may include an additional configuration according to the method it is realized. For example, in a case where the display device 230 is a liquid crystal type display device 230, the display device 230 may include an LCD display panel (not illustrated), backlight unit (not illustrated) that provides light to the LCD display panel, and panel driving plate (not illustrated) that drives the LCD display panel.

The storage 240 may store various programs and data necessary for operating the electronic device 200. The storage 240 may include a nonvolatile memory, volatile memory, flash-memory, hard disk drive (HDD) or solid state drive (SSD).

The storage 240 may be accessed by the controller 260, and may perform reading/recording/modifying/deleting/updating of data by the controller 260.

In the present disclosure, the storage 240 may be defined to include a ROM 262 or RAM 261 inside the controller 260, and a memory card (not illustrated) (for example, micro secure digital (SD) card, memory stick) mounted onto the electronic device 200. Furthermore, the storage 240 may store programs and data for configuring various screens to be displayed on the display area.

Furthermore, the storage 240 may match a value computed based on the type and depth information of a thing and store the same.

The communicator 250 is a configuration for communicating with various types of external devices according to various types of communication methods. The communicator 250 includes a Wifi chip, Bluetooth chip, wireless communication chip, NFC chip and the like. The controller 260 performs communication with various external devices using the communicator 250.

Especially, the Wifi chip and Bluetooth chip each performs communication in the Wifi method, and Bluetooth method, respectively. In a case of using the Wifi chip or Bluetooth chip, various connecting information such as an SSID and section key and the like is transceived first, and after being connected for communication using the various connecting information, various information may be transceived. A wireless communication chip refers to a chip that performs communication according to various communication standards such as IEEE, Zigbee, 3rd Generation (3G), 3rd Generation Partnership Project (3GPP), and long term evolution (LTE). An near-field communication (NFC) chip refers to a chip that operates in an NFC method that uses the 13.56 MHz band of among various radio frequency-identification (RF-ID) frequency bands such as 135 kHz, 13.56 MHz, 433 MHz, 860˜960 MHz, and 2.45 GHz.

The controller 260 controls the overall operations of the electronic device 200 using various programs stored in the storage 240.

As illustrated in FIG. 2, the controller 260 includes a RAM 261, ROM 262, graphic processor 263, main central processing unit (CPU) 264, first to n^{th} interfaces 265-1˜265-n, and bus 266. Herein, the random access memory (RAM) 261, read only memory (ROM) 262, graphic processor 263, main CPU 264, and first to n^{th} interfaces 265-1˜265-n may be connected to one another through a bus 266.

The ROM 262 stores command sets for system booting. In response to a turn on command being input and power being supplied, the main CPU 264 copies an operating system (O/S) stored in the storage 240 to the RAM 261, and executes the O/S to boot the system according to the command stored in the ROM 262. When the booting is completed, the main CPU 264 copies various application programs stored in the storage 240 to the RAM 261, and executes the application programs copied in the RAM 261 to perform various operations.

The graphic processor 263 generates a screen that includes various pieces of information such as an item, image, text and the like using an operator (not illustrated) and renderer (not illustrated). The operator computes attribute values such as a coordinate value, format, size and color by which various pieces of information are to be displayed according to a layout of the screen using a control command input by the user. The renderer generates a screen configured in various layouts including information based on the attribute value computed by the operator. The screen generated by the renderer is displayed within a display area of the display device 230.

The main CPU 264 accesses the storage 240, and performs booting using the O/S stored in the storage 240. Furthermore, the main CPU 264 performs various operations using various programs, contents, and data stored in the storage 240.

The first to n^{th} interfaces 265-1˜265-n are connected to the various aforementioned components. One of the interfaces may be a network interface connected to an external apparatus through a network.

Especially, the controller 260 extracts a hand area where the user's hand is included from a depth image obtained from the depth camera 210, models fingers and a palm of the user included in the hand area into a plurality of points, and senses a touch input based on depth information of the plurality of modeled points.

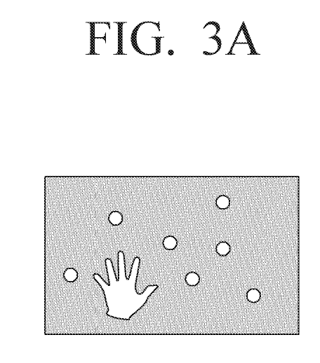

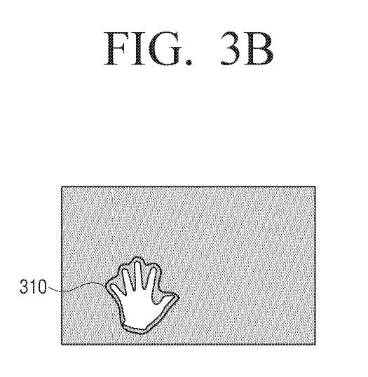

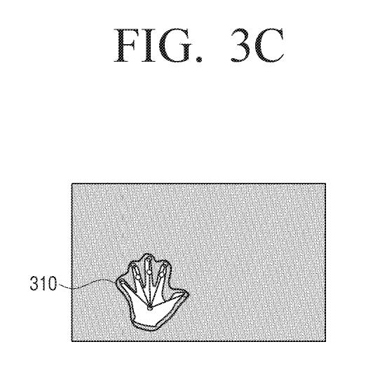

More specifically, the controller 260 obtains the depth image of the display area where an image is being projected by the display device 230. First of all, the controller 260 obtains a plane depth image where no object is placed on the display area. Furthermore, the controller 260 obtains a depth image, that is a photographed image of the display area where a certain object (for example, the user's hand, or thing) is placed. Furthermore, the controller 260 may measure a difference between the photographed depth image and the plane depth image, so as to obtain a depth image as illustrated in FIG. 3A.

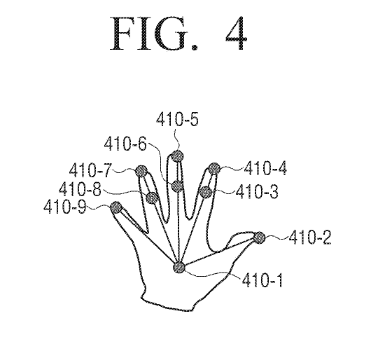

FIGS. 3A, 3B, 3C, and 4 are views for explaining extracting a hand area from a depth image obtained from a depth camera, and modeling a finger and palm of the extracted hand area into a plurality of points according to an embodiment of the present disclosure.

Furthermore, as illustrated in FIG. 3A, the controller 260 may remove a noise from a depth image based on a convex hull, and as illustrated in FIG. 3B, extract a hand area 310 that includes a person's hand.

Furthermore, the controller 260 may model a user's palm and fingers into a plurality of models based on depth information and shape of a hand area 310 as illustrated in FIG. 3C. In an embodiment of the present disclosure, as illustrated in FIG. 4, the controller 260 may model a palm into a first point 410-1, model a thumb into a second point 410-2, model an index finger into a third and fourth point 410-3, 410-4, model a middle finger into a fifth and sixth point 410-5, 410-6, model a ring finger into a seventh and eighth point 410-7, 410-8, and model a little finger into a ninth point 410-9. That is, a hand and finger model of a user is a simplification of a natural shape of a user's hand when typing on top of a plane of a desk. For example, as for the thumb and little finger, there may be no differentiation of joints that are not used, but the index finger, middle finger, and ring finger may be shown to have one joint each.

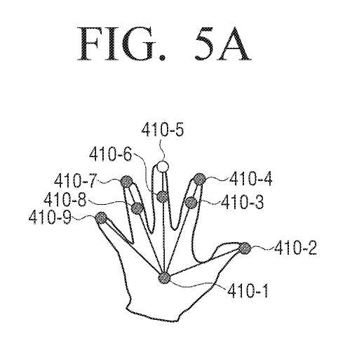

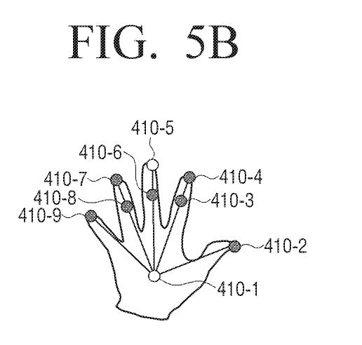

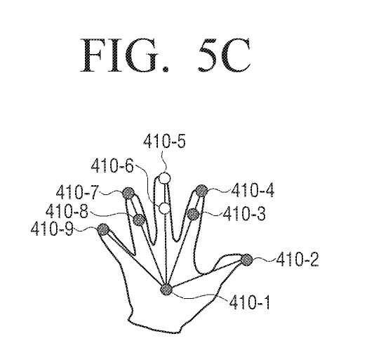

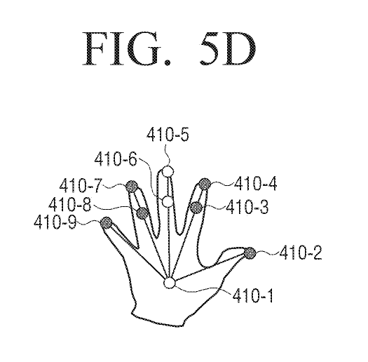

Furthermore, the controller 260 may sense a user's touch input based on depth information of the plurality of modeled points. This will be explained in more detail with reference to FIGS. 5A, 5B, 5C, 5D, 6A, 6B, 6C, 6D, 7A, 7B, 8A, and 8B.

FIGS. 5A, 5B, 5C, 5D, 6A, 6B, 6C, 6D, 7A, 7B, 8A, and 8B are views for explaining determining a touch input based on depth information on a plurality of points according to various embodiments of the present disclosure.

Referring to FIGS. 5A 5B, 5C, 5D, 6A, 6B, 6C, 6D, 7A, 7B, 8A, and 8B, in a case of existing outside a touch recognition distance on a reference plane, • may be used, and in a case of existing within the touch recognition distance on the reference plane, ∘ may be used.

First of all, in response to sensing that only end points 410-4, 410-5 of one of an index finger and middle finger have been touched, the controller 260 may sense a touch input in the touched point. More specifically, as illustrated in FIG. 5A, in a case where only an end point 410-5 of the middle finger is within the touch recognition distance, or as illustrated in FIG. 5B, in a case where an end point 410-5 of the middle finger and a palm point 410-1 are within the touch recognition distance, the controller 260 may sense a touch input in the point touched by the end point 410-5 of the middle finger.

However, in response to sensing that a plurality of points of one of the index finger and middle finger have been touched, the controller 260 may not sense a touch input. More specifically, in a case where a plurality of points 410-5, 410-6 of the middle finger are all within the touch recognition distance as illustrated in FIG. 5C, or in a case where all the plurality of points 410-5, 410-6 of the middle finger and the palm point 410-1 are all within the touch recognition distance as illustrated in FIG. 5D, the controller 260 may not sense a touch input. That is, when a user makes a touch, only an end part of the middle finger is touched and not all parts of the middle finger, and thus when it is sensed that all the plurality of points 410-5, 410-6 have been touched, the controller 260 may determine it as an unintended touch by the user and not sense a touch input.

Meanwhile, although FIGS. 5A to 5D were explained based on an example of using a middle finger, this is just an embodiment, and thus the same operations will be performed as FIGS. 5A to 5B when using an index finger instead.

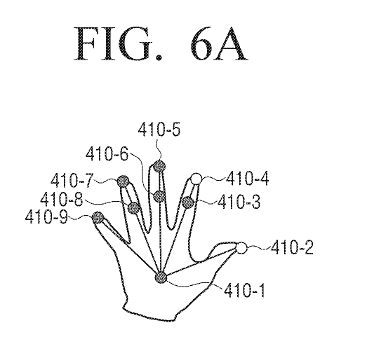

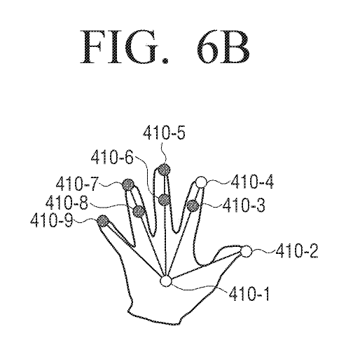

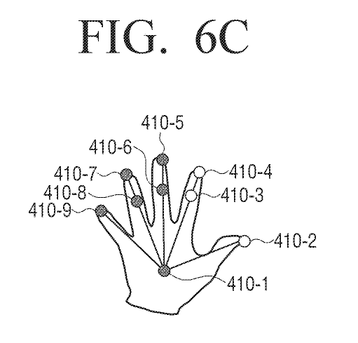

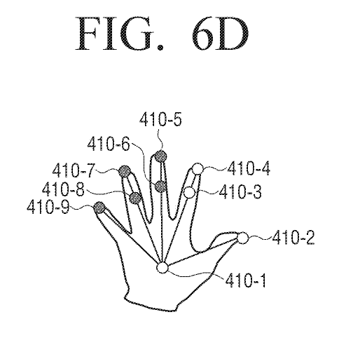

Furthermore, in a case of performing a multi touch using a thumb and index finger, in response to sensing that only end points of two fingers from among the plurality of points 410-2˜410-4 of the thumb and index finger have been touched, the controller 260 may sense a multi touch input in the touched point. More specifically, in a case where only an end point 410-4 of the index finger and an end point 410-2 of the thumb are within a touch recognition distance as illustrated in FIG. 6A, or in a case where an end point 410-2 of the index finger, an end point 410-2 of the thumb, and a palm point 410-1 are within the touch recognition distance as illustrated in FIG. 6B, the controller 260 may sense a multi touch input using the middle finger and thumb. That is, the controller 260 may provide various functions (for example, zoom-in, zoom-out of image and the like) according to distance change between the middle finger and the thumb.

However, in response to sensing that a plurality of points 410-3, 410-4 of the index finger and one point 410-2 of the thumb have all been touched, the controller 260 may not sense a touch input. More specifically, in a case where a plurality of points 410-3, 410-4 of the index finger and an end point 410-2 of the thumb are within a touch recognition distance as illustrated in FIG. 6C, or in a case where a plurality of points 410-3, 410-4 of the index finger, end point 410-2 of the thumb and a palm point 410-1 are all within the touch recognition distance as illustrated in FIG. 6D, the controller 260 may not sense a multi touch input.

Meanwhile, FIGS. 6A to 6D were explained using an index finger and thumb, but this is a mere embodiment, and thus the same operations will be made as illustrated in FIGS. 6A to 6D in the case of a multi touch input of using a middle finger and thumb.

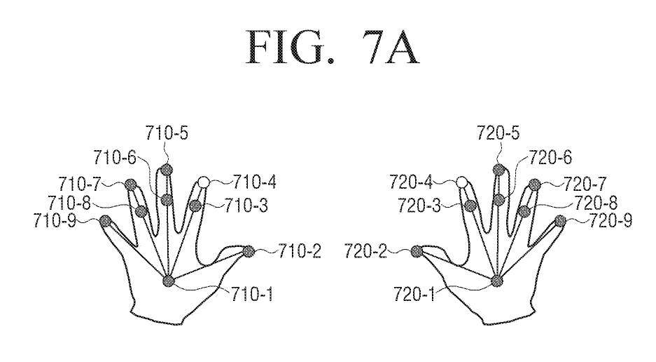

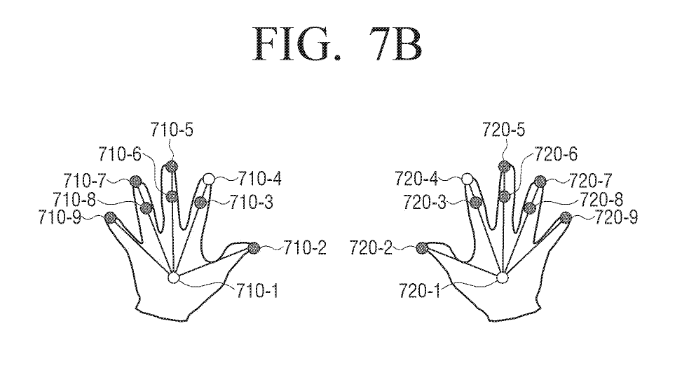

In an embodiment of the present disclosure, as illustrated in FIG. 7A, the controller 260 may for one hand model a palm into a first point 710-1, model a thumb into a second point 710-2, model an index finger into a third and fourth point 710-3, 710-4, model a middle finger into a fifth and sixth point 710-5, 710-6, model a ring finger into a seventh and eighth point 710-7, 710-8, and model a little finger into a ninth point 710-9. Similarly, the controller 260 may for another hand model a palm into a first point 720-1, model a thumb into a second point 720-2, model an index finger into a third and fourth point 720-3, 720-4, model a middle finger into a fifth and sixth point 720-5, 720-6, model a ring finger into a seventh and eighth point 720-7, 720-8, and model a little finger into a ninth point 720-9. That is, a hand and finger model of two hands of a user is a simplification of a natural shape of a user's hands when typing on top of a plane of a desk. For example, as for the thumb and little finger, there may be no differentiation of joints that are not used, but the index finger, middle finger, and ring finger may be shown to have one joint each.

Furthermore, in a case of inputting a multi touch using index fingers of both hands of the user, in response to sensing that only end points of two fingers from among a plurality of points of the index fingers of both hands of the user have been touched, the controller 260 may sense a multi touch input using the index fingers of both hands. More specifically, in response to only an end point 710-4 of an index finger of a left hand and an end point 720-4 of an index finger of a right hand being within a touch recognition distance as illustrated in FIG. 7A, or in response to only an end point 710-4 of an index finger of a left hand, a palm point 710-1 of a left finger, end point 720-4 of an index finger of a right hand, and a palm point 720-1 of a right hand being within a touch recognition distance as illustrated in FIG. 7B, the controller 260 may sense a multi touch input using middle fingers of both hands. That is, the controller 260 may provide various functions (for example, image zoom-in, zoom-out and the like) according to a change of distance between the middle fingers of both hands.

Referring to FIG. 7B, it was determined that palm points 710-1, 720-1 of both hands are both within a touch recognition distance, but this is a mere embodiment, and thus even in response to determining that only one of the palm points 710-1, 720-1 of both hands is within a touch recognition distance, the controller 260 may sense a multi touch input using middle fingers of both hands.

Furthermore, referring to FIGS. 7A and 7B, a case of using index fingers of both hands was explained, but this is a mere embodiment, and thus even in a case of using middle fingers of both hands, operation may be made in the same manner as in FIGS. 7A and 7B.

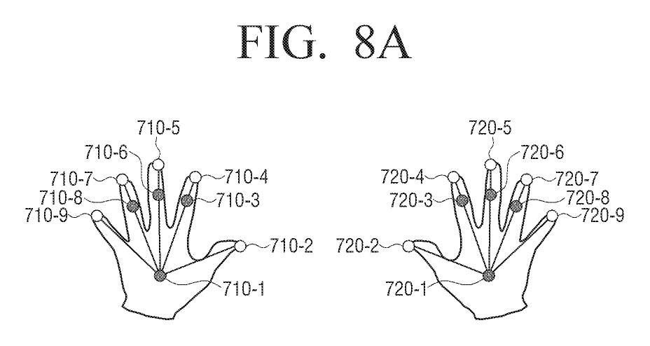

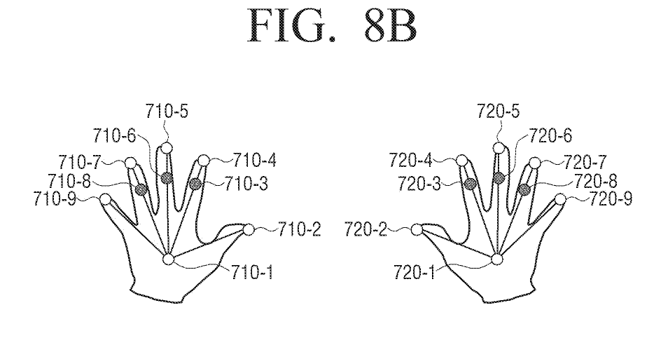

Furthermore, in a case of intending to input a multi touch using all fingers of both hands, in response to sensing that only end points of all fingers from among a plurality of points of all fingers of both hands of the user have been touched, the controller 260 may sense a multi touch input using both hands. More specifically, in response to end points 710-2,710-4, 710-5,710-7,710-9 of all fingers of a left hand and end points 720-2,720-4,720-5,720-7,720-9 of all fingers of a right hand being within a touch recognition distance as illustrated in FIG. 8A, or in response to end points 710-2,710-4, 710-5,710-7,710-9 of all fingers of a left hand, a palm point 710-1 of a left hand, end points 720-2,720-4,720-5,720-7,720-9 of all fingers of a right hand, and a palm point 720-1 of a right hand being within a touch recognition distance as illustrated in FIG. 8B, the controller 260 may sense a multi touch input using both hands. That is, the controller 260 may provide various functions (for example, image zoom-in, zoom-out and the like) according to a change of distance between both hands.

By sensing a touch input as illustrated in FIGS. 5A, 5B, 5C, 5D, 6A, 6B, 6C, 6D, 7A, 7B, 8A, and 8B, the electronic device 200 may sense a touch input through a touch operation of fingers regardless of whether or a user's palm is touching the bottom, and may not sense a touch input that is not intended by the user.

Furthermore, according to an embodiment of the present disclosure, in order to sense a touch input of a user more quickly, the controller 260 may analyze a movement direction and speed of a hand. Furthermore, the controller 260 may determine a position of a hand area of a user in a next frame based on a movement direction and speed of the hand analyzed in a previous frame, and extract the determined position of the hand area. Herein, the controller 260 may extract the hand area by cropping the hand area from a depth image.

Meanwhile, in the aforementioned embodiment, it was explained that a user's hand is extracted within a display area, but this is a mere embodiment, and a thing may be extracted instead of a user's hand.

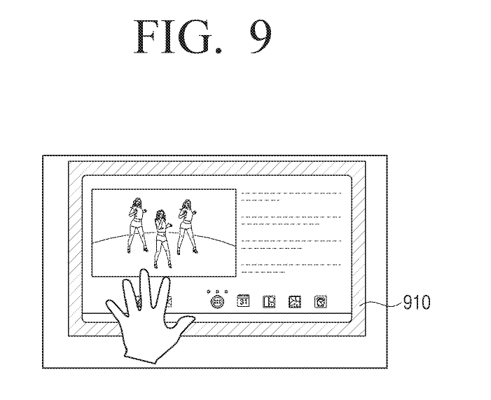

More specifically, the controller 260 may analyze a depth image obtained through the depth camera 210 and determine whether an object within the obtained depth image is a user's hand or a thing. More specifically, the controller 260 may determine the type of an object located within a display area using a difference between a plane depth image and the depth image photographed through the depth camera 210. Herein, the controller 260 may extract a color area of the object within the depth image, and determine whether the object is a person's hand or thing using an image of the thing divided according to an extracted exterior area. Otherwise, in response to there being a difference of depth image in a determination area 910 that is located in a circumference of the image as illustrated in FIG. 9, the controller 260 may determine that there is a person's hand, and in response to there not being a difference of the depth image in the determination area 910, the controller 260 may determine that there is a thing.

FIG. 9 is a view illustrating a touch area according to an embodiment of the present disclosure.

Furthermore, in response to determining that the object within the depth image is a thing, the controller 260 may determine the type of the extracted thing. More specifically, the controller 260 may calculate a size area, depth area, depth average, and depth deviation based on depth information of the thing, multiply the calculated result with a weighted value, and sum the results to derive a result value. Furthermore, the controller 260 may compare the result values matched to the types of the things and stored with the derived result values, so as to determine the type of the thing within the depth image.

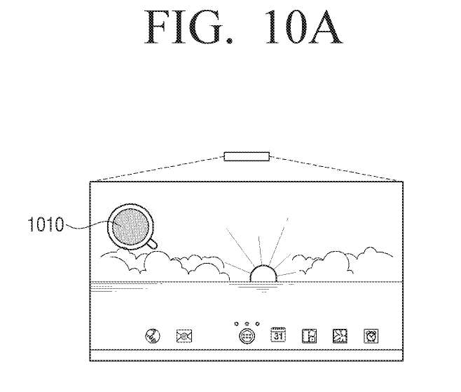

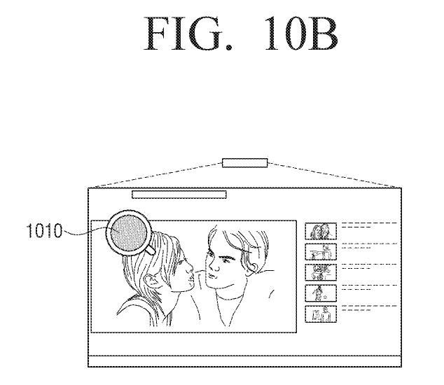

Furthermore, the controller 260 may control functions of the electronic device 100 according to the determined type of the thing. For example, in response to determining that the type of the thing 1010 placed on a display area while a first screen is being displayed is a cup as illustrated in FIG. 10A, the controller 260 may perform a command (for example, video application execution) matching the cup. That is, as illustrated in FIG. 10B, the controller 260 may control the display device 230 to display a second screen (video application execution screen). In another example, in response to determining that the type of a thing placed on a display area while a first screen is being displayed is a notebook, the controller 260 may perform a command (for example, memo application execution) matching the notebook.

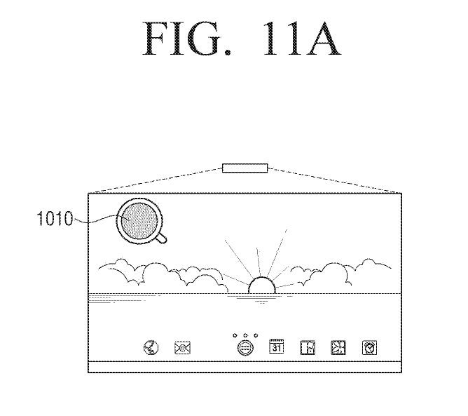

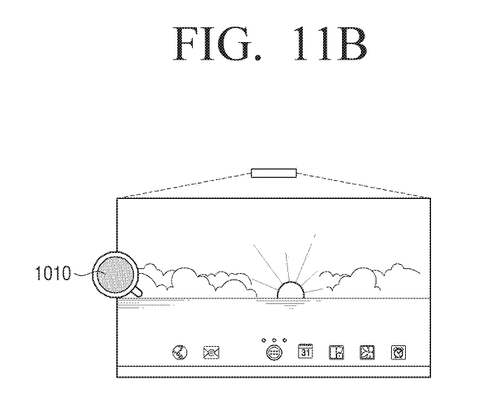

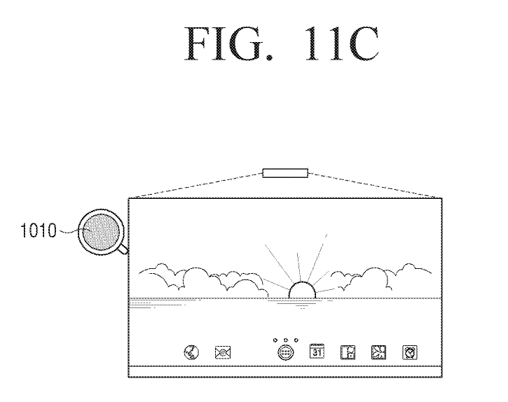

FIGS. 10A, 10B, 11A, 11B, and 11C are views for explaining controlling an electronic device using a thing according to an embodiment of the present disclosure.

Furthermore, functions of the electronic device 200 may be executed according to the type of the thing regardless of the location of the thing, but this is a mere embodiment, and thus the controller 260 may provide different functions depending on the location of the thing. That is, the controller 260 may provide different functions in response to the thing 1010 being within a display area as illustrated in FIG. 11A, the thing 1010 being on a boundary being the display area and exterior as illustrated in FIG. 11B, the thing 1010 being on an exterior of the display area as illustrated in FIG. 11C. For example, in response to the thing 1010 being within the display area as illustrated in FIG. 11A, the controller 260 may execute a video application, and in response to the thing 1010 being on a boundary between the display area and exterior as illustrated in FIG. 11B, the controller 260 may execute a music application, and in response to the thing 1010 being on an exterior of the display area as illustrated in FIG. 11C, the controller 260 may convert the electronic device 100 into waiting mode. Furthermore, it is a matter of course that different functions may be provided depending on the location of the thing 1010 within the display area.

Furthermore, in response to the thing 1010 being located on an exterior of the display area, the controller 260 may control the display device 230 to display a shortcut icon near the thing 1010 in the display area.

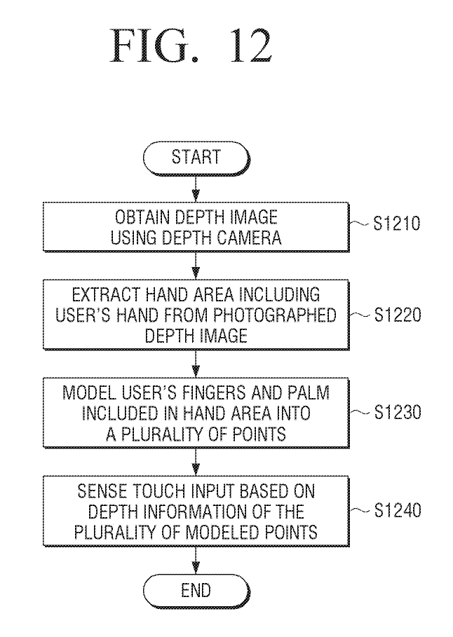

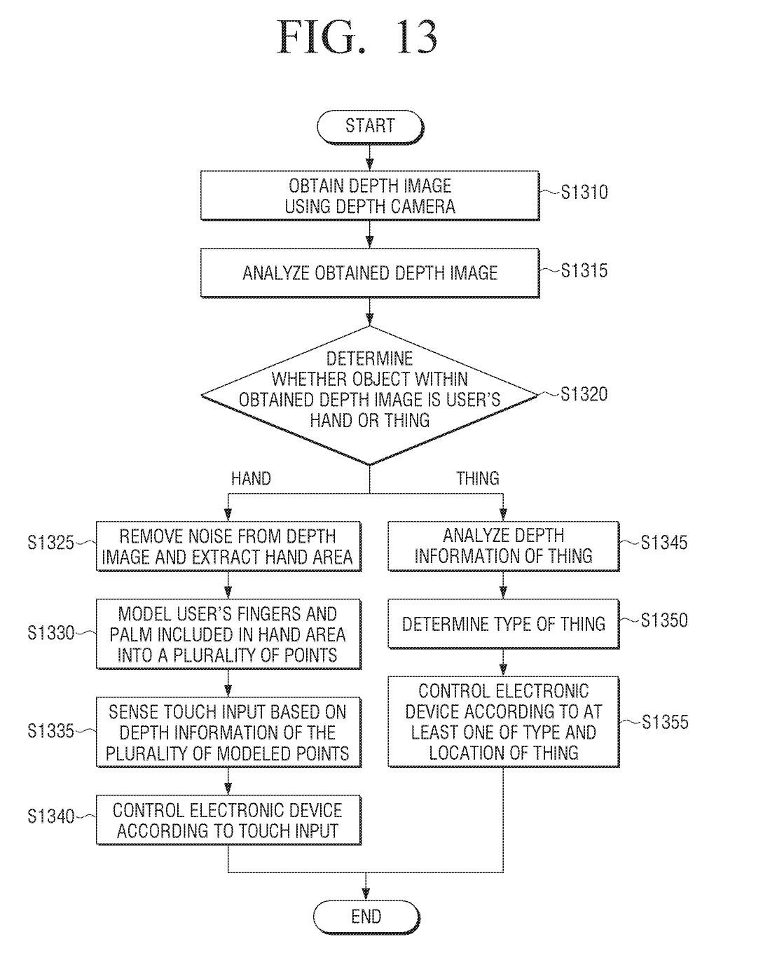

Hereinafter, a method for controlling the electronic device 100 will be explained with reference to FIGS. 12 and 13. FIG. 12 is a flowchart for explaining the method for controlling the electronic device 100 according to an embodiment of the present disclosure.

First of all, the electronic device 100 obtains a depth image using a depth camera in operation S1210. More specifically, the electronic device 100 may obtain the depth image within a display area.

Furthermore, the electronic device 100 extracts a hand area where a user's hand is included from the photographed depth image in operation S1220. Herein, the electronic device 100 may remove noise from the depth image and extract a user's hand area.

In addition, the electronic device 100 models the user's fingers and palm included in the hand area into a plurality of points in operation S1230. More specifically, the electronic device 100 may model each of an index finger, middle finger, and ring finger of the user's fingers into a plurality of points, model each of a thumb and little finger of the user's fingers into one point, and model a palm of the user into one point.

Furthermore, the electronic device 100 senses a touch input based on depth information of the plurality of modeled points in operation S1240. More specifically, the electronic device 100 may sense a touch input as in various embodiments of FIG. 5A to 8B.

FIG. 13 is a flowchart for explaining a method for controlling the electronic device 100 according to an embodiment of the present disclosure.

First of all, the electronic device 100 obtains a depth image using the depth camera in operation S1310. More specifically, the electronic device 100 may analyze the depth image using a difference between a plane depth image and the photographed depth image in operation S1315.

Furthermore, the electronic device 100 determines whether or not an object within the obtained depth image is a person's hand in operation S1320.

In response to determining that the object is a person's hand, the electronic device 100 removes noise from the depth image and extracts a hand area in operation S1325.

Furthermore, the electronic device 100 models a user's fingers and a palm included in the hand area into a plurality of points in operation S1330, senses a touch input based on depth information of the plurality of modeled points in operation S1335, and controls the electronic device 100 according to the sensed touch input in operation S1340.

However, in response to determining that the object is a thing, the electronic device 100 analyzes the depth information of the thing in operation S1345, determines the type of the thing based on a result of the analysis in operation S1350, and controls the electronic device 100 according to at least one of the determined type and location of the thing in operation S1355.

According to the aforementioned various embodiments of the present disclosure, it is possible to improve user convenience of touch inputs using the depth camera. Furthermore, the electronic device 100 may provide various types of user inputs using the depth camera.

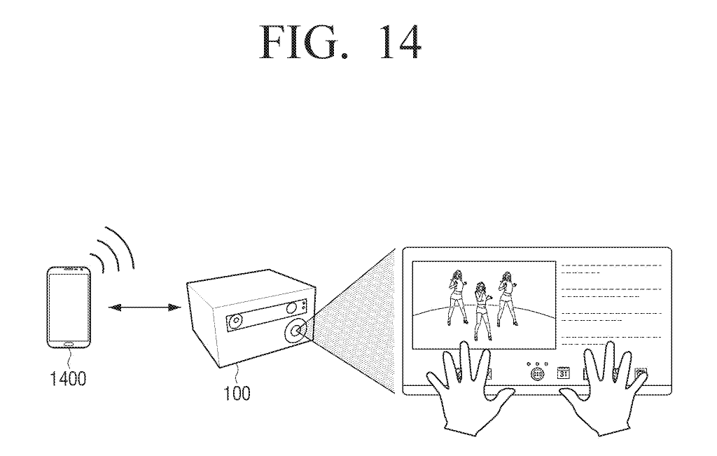

Meanwhile, in the aforementioned embodiments, it was explained that the electronic device 100 directly displays an image, senses a touch input, and performs functions according to the touch input, but these are mere embodiments, and thus the functions of the controller 120 may be performed through an external portable terminal 1400. More specifically, as illustrated in FIG. 14, the electronic device 100 may simply output an image using a beam projector, and obtain a depth image using the depth camera, and the external portable terminal 1400 may provide an image to the electronic device 100, and analyze the depth image to control functions of the portable terminal 1400 and electronic device 100. That is, the external portable terminal 1400 may perform the aforementioned functions of the controller 120.

FIG. 14 is a view for explaining controlling an electronic device through an external user terminal according to an embodiment of the present disclosure.

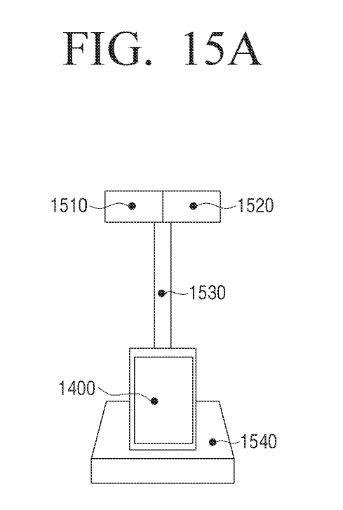

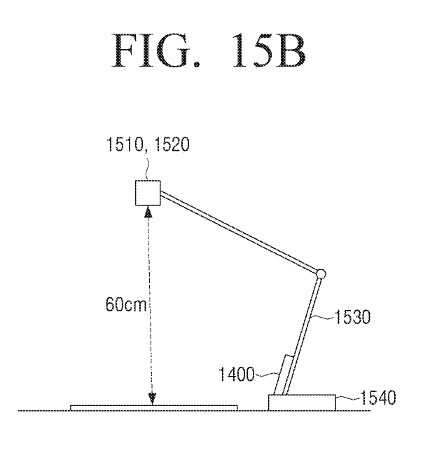

Furthermore, the electronic device 100 according to an embodiment of the present disclosure may be realized as a stand type beam projector. More specifically, FIG. 15A is a view illustrating a front view of the stand type beam projector according to an embodiment of the present disclosure, and FIG. 15B is a view illustrating a side view of the stand type beam projector according to an embodiment of the present disclosure.

Referring to FIG. 15A and FIG. 15B, the stand type beam projector may have a beam projector 1510 and depth camera 1520 on its upper end, and a foldable frame 1530 and docking base 1540 may support the beam projector 1510 and depth camera 1520. The electronic device 100 may project light to a display area using the beam projector 1510 located on its upper end, and sense a touch input regarding the display area using the depth camera 1520. Furthermore, the user may adjust the display area by adjusting the foldable frame 1530. Furthermore, the external portable terminal 1400 may be rested on the docking base 1540.

Meanwhile, the aforementioned method may be realized in a general use digital computer configured to operate a program using a non-transitory computer readable record medium that is capable of writing a program executable in the computer and of reading the program using the computer. Furthermore, a structure of data used in the aforementioned method may be recorded in the non-transitory computer readable record medium through various means. Examples of the non-transitory computer readable record medium include storage media such as a magnetic storage medium (for example, ROM, floppy disk, hard disk and the like), optic readable medium (for example, compact disc (CD) ROM, digital versatile disc (DVD) and the like).

While the present disclosure has been shown and described with reference to various embodiments thereof, it will be understood by those skilled in the art that various changes in form and details may be made therein without departing from the spirit and scope of the present disclosure, defined by the appended claims and their equivalents.

What is claimed is:

1. A method for controlling an electronic device, the method comprising:
obtaining a depth image using a depth camera;
extracting a hand area including a hand of a user from the obtained depth image;
modeling fingers and a palm of the user included in the hand area into a plurality of points; and
sensing a touch input based on depth information of one or more of the plurality of modeled points.

2. The method according to claim 1, wherein the modeling comprises:
modeling each of an index finger, middle finger, and ring finger of the fingers of the user into a plurality of points;
modeling each of a thumb and little finger of the fingers of the user into one point; and
modeling the palm of the user into one point.

3. The method according to claim 2, wherein the sensing comprises:
in response to sensing that only an end point of at least one finger from among the plurality of points of the index finger and middle finger has been touched, sensing a touch input at the touched point; and
in response to sensing that a plurality of points of at least one finger from among the plurality of points of the index finger and middle finger have been touched, not sensing the touch input.

4. The method according to claim 2, wherein the sensing comprises:
in response to sensing that only end points of two fingers from among the plurality of points of the thumb and index finger have been touched, sensing a multi touch input at the touched point; and
in response to sensing that the plurality of points of the index finger and the one point of the thumb have all been touched, not sensing the touch input.

5. The method according to claim 2, wherein the sensing comprises:
in response to sensing that only end points of two fingers from among the plurality of points of the index fingers of both hands of the user have been touched, sensing a multi touch input at the touched point.

6. The method according to claim 2, wherein the sensing comprises:
in response to sensing that only end points of all fingers from among the plurality of points of all fingers of both hands of the user have been touched, sensing a multi touch input.

7. The method according to claim 1, further comprising:
analyzing a movement direction and speed of the hand included in the hand area,
wherein the extracting comprises extracting the hand of the user based on a movement direction and speed of the hand analyzed in a previous frame.

8. The method according to claim 1, further comprising:
determining whether an object within the obtained depth image is a hand or thing by analyzing the obtained depth image; and
in response to determining that the object within the depth image is a thing, determining a type of the thing.

9. The method according to claim 8, further comprising:
performing functions of the electronic device based on the determined type of the thing and touch position of the thing.

10. An electronic device comprising:
a depth camera configured to obtain a depth image; and
a controller configured to:
extract a hand area including a hand of a user from the obtained depth image,
model the fingers and palm of the user included in the hand area into a plurality of points, and
sense a touch input based on depth information of one or more of the plurality of modeled points.

11. The electronic device according to claim 10, wherein the controller is further configured to:
model each of an index finger, middle finger, and ring finger from among the fingers of the user into a plurality of points;
model each of a thumb and little finger of the fingers of the user into one point; and
model the palm of the user into one point

12. The electronic device according to claim 11, wherein the controller is further configured to:
in response to sensing that only an end point of at least one finger from among the plurality of points of the index finger and middle finger have been touched, sense a touch input at the touched point; and
in response to sensing that a plurality of points of at least one finger from among the plurality of points of the index finger and middle finger have been touched, not sense the touch input.

13. The electronic device according to claim 11, wherein the controller is further configured to:
in response to sensing that only end points of two fingers from among the plurality of points of the thumb and index finger have been touched, sense a multi touch input at the touched point; and
in response to sensing that the plurality of points of the index finger and one point of the thumb have all been touched, not sense the touch input.

14. The electronic device according to claim 11, wherein the controller is further configured to:
in response to sensing that only end points of two fingers from among the plurality of points of the index fingers of both hands of the user have been touched, sense a multi touch input at the touched point.

15. The electronic device according to claim 11, wherein the controller is further configured to:
in response to sensing that only end points of all fingers from among the plurality of points of all fingers of both hands of the user have been touched, sense a multi touch input.

16. The electronic device according to claim 10, wherein the controller is further configured to:
analyze a movement direction and speed of the hand included in the hand area; and
extract the hand of the user based on a movement direction and speed of the hand analyzed in a previous frame.

17. The electronic device according to claim 10, wherein the controller is further configured to determine whether an object within the obtained depth image is the of the user hand or a thing by analyzing the obtained depth image; and
in response to determining that the object within the depth image is a thing, determine a type of the thing.

18. The electronic device according to claim 17, wherein the controller is further configured to perform functions of the electronic device based on the determined type of the thing and touch position of the thing.

19. The electronic device according to claim 10, further comprising:
an image projector configured to project an image onto a touch area.
